(19) United States
(12) Patent Application Publication
(10) Pub. No.: US 2006/0225552 A1
(43) Pub. Date: Oct. 12, 2006

(54) Cutting machine

(76) Inventor: Luca Lee, Tu-Cheng City (TW)

Correspondence Address: TROXELL LAW OFFICE PLLC, SUITE 1404, 5205 LEESBURG PIKE, FALLS CHURCH, VA, 22041, US

(21) Appl. No.: 11/099,643

(22) Filed: Apr. 6, 2005

(51) Int. Cl. B26D 1/00

(52) U.S. Cl. 83/651

(57) ABSTRACT

An improved cutting machine with a simple structure, easy assembly, and good cutting effect is provided. One side of the cutting board is provided with a cutter and a ruler, while the other side is provided with a rotary blade capable of rotating. The rotary blade base and the rotary frame can rotate vertically or horizontally, and the rotary lever and the rotary blade are easily replaceable.

### BACKGROUND OF THE INVENTION

Generally, secretaries and graphic designers often need to use tools to cut paper, film, cellophane paper or plastic sheets. The most frequently used cutting tools are scissors, rulers, and cutters, but they are limited to few cuttings. For frequent users or for cuttings other than straight cuttings, such as cuttings in wave or sewing form, a cutting machine is more convenient and efficient.

The above-mentioned conventional cutting machine refers to a guillotine-type cutting machine. Such cutting machine has evolved to have multiple functions. For example, a paper trimmer that has a guillotine type blade and a rotary trimmer integrally formed. However, whether it is a single function cutting machine or a two-in-one cutting machine, there still exist many disadvantages, such as the structure is complex, the assembly thereof is troublesome, and the cutting is not practical.

The inventor has many years of experience in developing and manufacturing such products. After years of improvement, the present invention is finally reduced to practice. The design of the present invention is to provide a single-axle blade and a ruler on one side of the cutting machine, while a rotary blade is provided on the other side. The rotary blade base and the rotary frame can rotate vertically or horizontally, and the rotary lever and the rotary blade are characterized in an easily assembled structure.

### SUMMARY OF THE INVENTION

The present invention provides an improved cutting machine. A cutter and a ruler are provided on one side of the cutting board, while a rotary blade is provided on another side. The rotary blade and the rotary frame can rotate vertically or horizontally, and the rotary lever and the rotary blade are characterized in an easily assembled structure.

### DESCRIPTION OF THE DRAWINGS

FIG. 1 is a 3D view of the present invention;

FIG. 2 is a 3D exploded view of the present invention;

FIG. 3 is a 3D schematic view of the rotary frame in accordance with the present invention;

FIG. 4 is a 3D schematic view of a cutting pad assembly in accordance with the present invention;

FIG. 5 is a 3D schematic view of a curved cutter in accordance with the present invention;

FIG. 6 is a 3D schematic view of the curve of the ruler in accordance with the present invention;

FIG. 7 is a 3D exploded view of a rotary blade base in accordance with the present invention;

FIG. 8 is a rotation operation view of the rotary frame and the rotary blade base in accordance with the present invention; and

FIG. 9 is a 3D view of the screw assembly screwing the cutter in accordance with the present invention.

### DESCRIPTION OF THE EMBODIMENTS

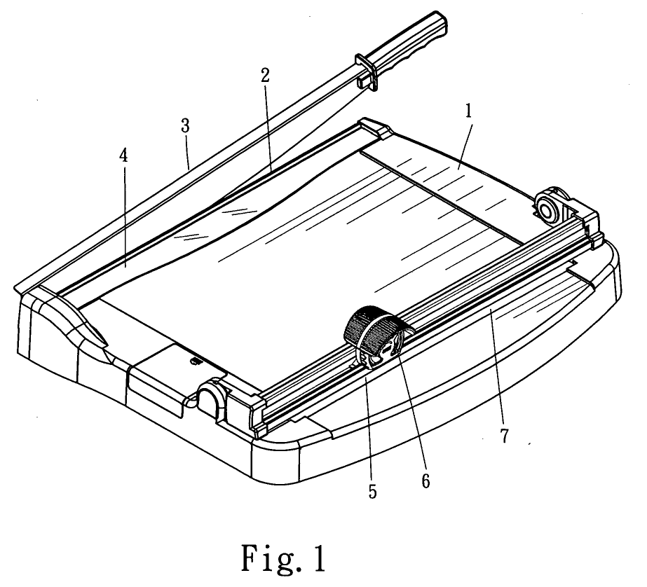

Refer to FIG. 1. The improved cutting machine of the present invention includes a cutting board 1, a straight cutter base 2, a cutter 3, a ruler 4, a rotary frame 5, a rotary blade base 6, and a cutting pad 7.

One side of the cutting board 1 is screwed with a straight cutter base 2, and the same side of the cutting board 1 is provided with a protrusion 11 so as to allow a cutter 3 to be screwed on the side of the cutting board, and to form a cross-sectional cutting plane with the straight cutter base 2. As shown in FIG. 9, a screwing cap used to screw the cutter 3 is a gel cap 31 having a gel layer 311 added to the internal screw so that after a screw 32 is screwed into the gel cap 31, it will not be loosened or shifted. The cap further has a disc-typed spring gasket 33, so that when the cutter 3 is screwed, an appropriate tension is formed to enhance the cutting effect. In addition, the cutting board 1 is provided with a pad 12 on the side corresponding to the cutter 3, so that when the cutter 3 is pushed to the bottom, buffer is provided to prevent noise.

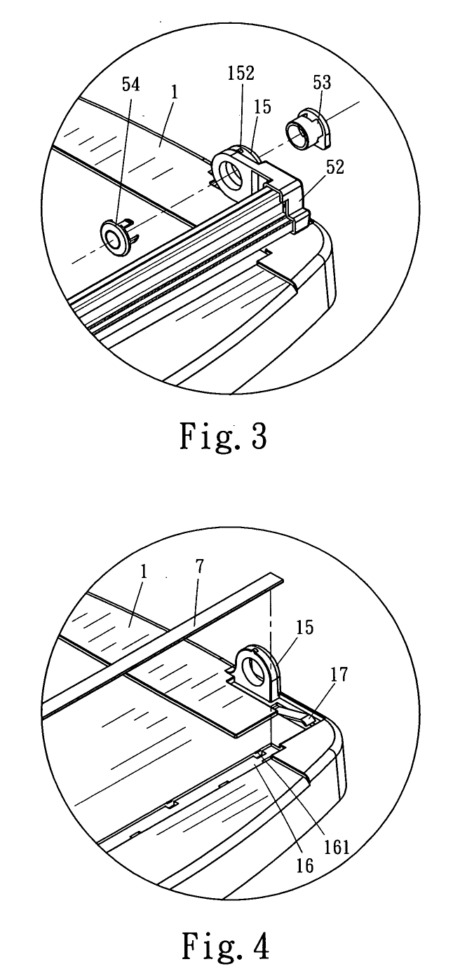

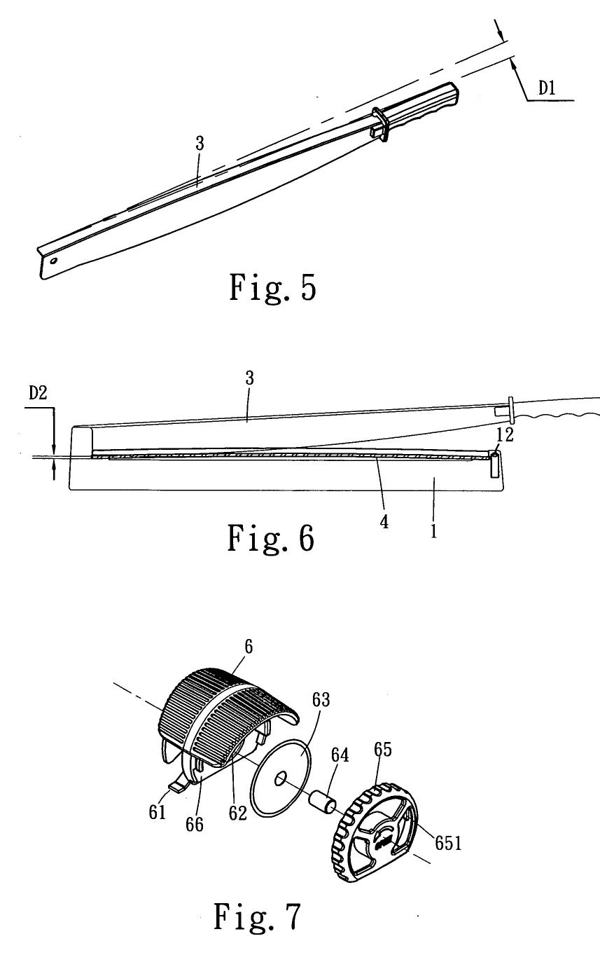

Refer to FIG. 3. The cutter 3 of the present invention is appropriately curved (as shown by the vertical distance D1 in the figure). It is accompanied by the appropriate tension mentioned above to obtain better cutting.

Furthermore, the inner side of the straight cutter base 2 on the cutting board 1 is provided with an engaging hole 13 on the front end and the back end respectively, so as to provide a flange 41 on the two sides of a ruler 4 to be placed into the engaging hole 13 to position the ruler 4. As shown in FIG. 6, the ruler 4 is designed to be curved in the middle (as shown by the vertical distance D2 in the figure). The curve is designed such that after the ruler 4 is positioned, a horizontal plane of the cutting board 3 is presented with an appropriate gap with the ruler 4 to facilitate easy placement of a cutting item, such as paper, into a cutting position.

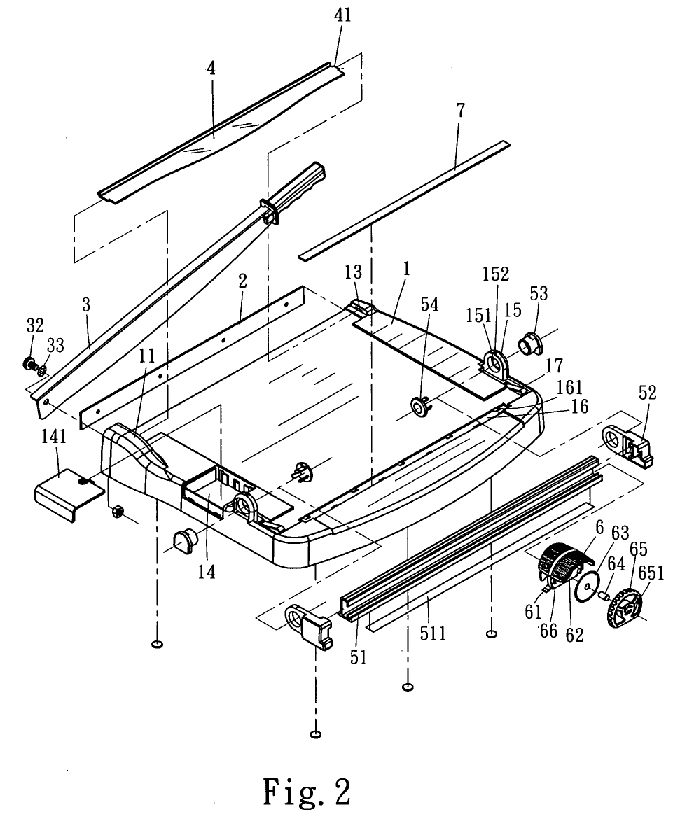

Refer to FIG. 2. An appropriate place on one side of the cutting board is provided with a containing groove 14 and a cover thereof 141 so as to allow a variety of rotary blades or small stationery to be placed therein. Another side of the cutting board 1 is provided with a pair of corresponding axle-supporting bases 15. An axle-supporting hole 151 is in the center of the axle-supporting base 15. The top of the axle-supporting base 15 is provided with a protrusion 152, so as to position the rotary frame 5 when it is rotated to a vertical position.

Refer to FIG. 2. A rotary frame 5 has a rolling rail 51 in the center portion. The bottom of the rolling rail 51 is stuck with a stopping pad 511. The two sides of the rolling rail 51 are provided with a pair of corresponding rotary bases 52 to correspond to the axle-supporting base 15. The assembly of the rotary base 52 and the axle-supporting base 15 is an engagement of a corresponding bearing cylinder 53 and an engaging piece 54.

Refer to FIG. 7. A rotary blade base 6 can be inserted into the rolling rail 51. The rotary blade base 6 downwardly provides an elastic piece 61 such that when it is placed into the rolling rail 51, an upward tension is formed. One side of the rotary blade base 6 is provided with an axle hole 62, allowing a variety of rolling cutters 63 in straight line, wave, sewing forms to be engaged with an engaging cover 65 after an axle 64 is inserted. The engagement is performed by providing a flange 66 on one side of the rotary blade base 6 to accommodate the engaging block 651 on the inner side of the engaging cover 65, and thus it is securely fastened with each other respectively so as to provide easy placement of the rotary blade 63.

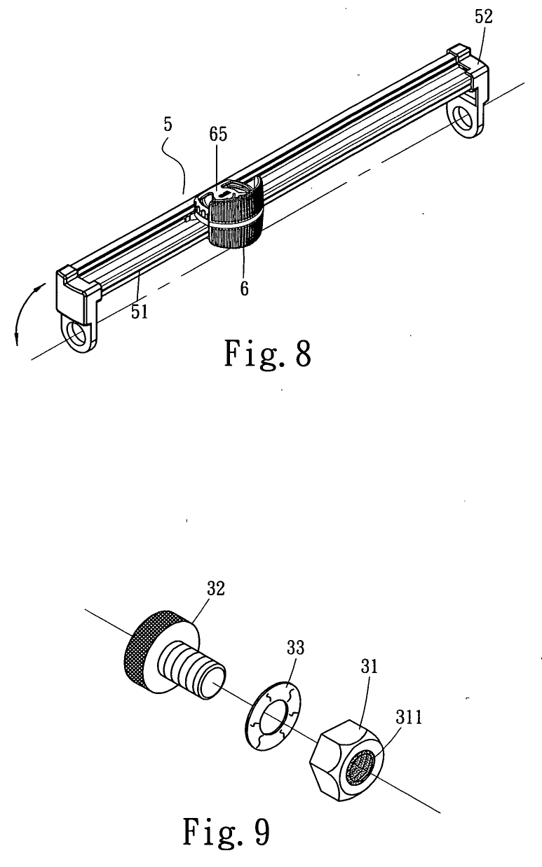

Refer to FIG. 8. The above-mentioned rotary frame 5 along with the rotary blade base 6 thereon can be presented horizontally to the cutting item or be vertically rotated to facilitate cutting operation.

As shown in FIG. 4, the cutting board 1 is provided with an engaging groove 16 at a place corresponding to the rotary blade 63 on the rotary blade base 6 so as to place a cutting pad 7 therein. The two sides of the engaging groove 16 are provided with protrusions 161 alternatively on the two sides, so as to allow easy placement of the cutting pad 7 as well as to ensure positioning. Furthermore, a pair of corresponding elastic pieces 17 are provided on the two sides of the engaging groove 16 on the cutting board 1 so as to maintain an appropriate gap with the cutting item when the rotary blade base 6 is horizontal in relation to the cutting item to facilitate easy placement of the cutting item, such as paper, into the cutting position.

In summary, the present invention provides a cutting machine with a simply structure, easy operation, and great cutting effect.

What is claimed is:

1. An improved cutting machine, comprising a cutting board, a straight cutter base, a cutter, a ruler, a rotary frame, a rotary blade base, and a cutting pad, comprising:
a cutting board providing a protrusion and an engaging hole on one side, said cutting board providing a containing groove and a cover thereof in an appropriate location on one side, while an axle-supporting base and an engaging groove provided symmetrically on another side, wherein the center of said axle-supporting base is an axle-supporting hole;
a straight cutter base secured on one side of said cutting board;
a cutter screwed on said protrusion on one side of said cutting board;
a ruler provided with flanges on two sides, said engaging hole placed in said flange securing said ruler on said cutting board;
a rotary frame having a rolling rail in the center, a stopping pad stuck on the bottom of said rolling rail, two sides of said rolling rail provided with said rotary base corresponding to said axle-supporting base, the assembly of said rotary base and said axle-supporting base being an engaging assembly of a corresponding bearing cylinder and an engaging piece, the structure allowing said rotary frame along with said rotary blade base thereon to be horizontal in relation to a cutting item or to rotate vertically;
a rotary cutter base, capable of inserting into said rolling rail, said rotary blade base downwardly provided with an elastic piece, said rotary blade base provided with an axle hole on one side allowing a variety of rolling cutters in straight line, wave, sewing forms to be engaged with an engaging cover after an axle is inserted;
a cutting pad placing in said engaging groove.

2. The improved cutting machine of claim 1, wherein said ruler is designed to be curved in the middle such that after said ruler is positioned, a horizontal plane of said cutting board is presented with an appropriate gap with said ruler.

3. The improved cutting machine of claim 1, wherein a cap screwing said cutter is a gel cap having a gel layer added to the internal screw so that after said screw is screwed into said gel cap, said screw will not be loosened or shifted, said cap further having a disc-shaped spring gasket, so that when said cutter is screwed, an appropriate tension is formed, and said cutter having a pad on one side.

4. The improved cutting machine of claim 1, wherein said cutter is appropriately curved.

5. The improved cutting machine of claim 1, wherein the top of said supporting base of said cutting board is provided with a protrusion so as to position as said rotary frame is rotated vertically.

6. The improved cutting machine of claim 1, wherein said rotary blade base is provided with a flange on one side accommodating an engaging block on the internal side of an engaging cover, engagingly fastened with each other so as to provide easy replacement of said rotary blade.

7. The improved cutting machine of claim 1, wherein an engaging groove of said cutting board allowing a cutting pad to be placed therein is provided with protrusions alternately on both sides so as to allow easy placement of said cutting pad and to ensure positioning.

8. The improved cutting machine of claim 1, wherein elastic pieces are provided symmetrically on both sides of said engaging groove on said cutting board, so as to allow said rotary blade base to maintain an appropriate gap with said cutting board.
